(19) United States
(12) Patent Application Publication
(10) Pub. No.: US 2026/0351042 A1
(43) Pub. Date: Nov. 5, 2026

(54) SYSTEM AND METHOD UTILIZING FACIAL RECOGNITION AND COMPUTER VISION TO ENHANCE HOSPITALITY SERVICES

(71) Applicant: LAS VEGAS SANDS CORP., Las Vegas, NV (US)

(72) Inventors: Matthew Richard Perkins, Las Vegas, NV (US); Vernon Anthony Allen, Macau (CN); Christian Tuchez, Orlando, FL (US); Yue Woon HIANG, Singapore (SG)

(21) Appl. No.: 19/197,793

(22) Filed: May 2, 2025

(51) Int. Cl. G06V 40/16; G06Q 10/0639; G06Q 50/12; G06T 7/20; G06V 20/40; G06V 20/52

(52) U.S. Cl. CPC G06V 40/172; G06Q 10/06393; G06Q 50/12; G06T 7/20; G06V 20/44; G06V 20/52

(57) ABSTRACT

A computer system configured to facilitate hospitality services in a resort includes cameras configured to capture images of at least a portion of the resort and a computing device in electronic communication with the cameras that includes a processor and a non-transitory memory device. The non-transitory memory includes computer-readable instructions which, when executed by the processor, cause the computing device to: receive the images captured by at least one of the cameras; identify, utilizing a facial recognition module, at least one individual in the images captured by the camera; and determine, utilizing a computer vision module, performance of a service for the at least one individual. The system also includes an electronic device configured to display information regarding the service event.

### BACKGROUND

### 1. Field

The present disclosure relates to facial recognition and computer vision.

### 2. Description of the Related Art

Hospitality services at a resort typically rely solely on human attention and action. For instance, restaurant services (e.g., refilling a patron's drink, taking the patron's food order when ready, and bringing the check once the patron has completed his meal service), typically require the waitstaff to notice that these services are required, which may result in delays if the waitstaff is busy or inattentive. Moreover, without automated computer-based supervision, it is difficult to determine if the service providers are satisfying the establishment's service standards, such as the timeliness and/or frequency of performing certain tasks for guests. Additionally, service standards may be particularly poor in regions where the service providers are not incentivized by tips or other forms of performance-based remuneration. Furthermore, certain guests may have their unique individual service standards, and it may be difficult for establishments to meet these individualized service standards because those individual services standards may not be recorded in a centralized database and it may be difficult to identify when that guest has arrived, particularly if a reservation is not booked under that individual's name.

The above information disclosed in this Background section is only for enhancement of understanding of the background of the invention and therefore it may contain information that does not constitute prior art.

### SUMMARY

The present disclosure relates to various embodiments of a computer-based system configured to facilitate hospitality services in a resort. The computer system includes cameras configured to capture images of at least a portion of the resort and a computing device in electronic communication with the cameras and including a processor and a non-transitory memory device in communication with the processor. The non-transitory memory device includes computer-readable instructions which, when executed by the processor, cause the computing device to: receive the images captured by at least one of the cameras; identify, utilizing a facial recognition module, at least one individual in the images captured by at least one of the cameras; determine, utilizing a computer vision module, performance of a service for the individual; and compare the performance of the service to a service standard stored in the non-transitory memory device. The system also includes an electronic device in electronic communication with the computing device that is configured to generate an alert in response to the service not meeting the service standard.

The electronic device may be a tablet computer, a computer monitor, a virtual reality headset, an augmented reality headset, a smart watch, a smartphone, or an earpiece.

The alert may be an auditory alert or a visual alert.

The electronic device may be a display device, and the display device may be configured to display a graphical user interface including a graphical representation of a layout of the portion of the resort, an identification of a location of the at least one individual in the layout, and the service standard associated with the at least one individual.

The display device may be further configured to display an identity of the at least one individual.

The non-transitory memory device may include a facial recognition database including facial images, identifications associated with the facial images, and preferences associated with the identifications.

The non-transitory memory device may include a computer vision database including events, service tasks associated with the events, and service standards associated with the service tasks.

At least one of the service standards may be based on one of the preferences.

The computer vision module may include a convolutional neural network.

The computer-readable instructions, when executed by the processor, may further cause the computing device to determine, utilizing the computer vision module, an occurrence of an event involving the at least one individual.

The event may be a guest arriving at a restaurant, a table becoming available, the guest being ready to order, the guest finishing a drink, the guest finishing a meal, or the guest departing the restaurant.

The service standard may be a time duration, a frequency, or a number of occurrences.

The portion of the resort may be a restaurant, a front desk area, a casino, a convention space, a meeting room, a housekeeping area, a pool area, or a valet area.

The non-transitory memory device may store preferences of the at least one individual, and the computer-readable instructions, when executed by the processor, may cause a display of the electronic device to display a name of the at least one individual and the preferences of the at least one individual in response to the facial recognition module identifying the at least one individual.

The preferences may include meal preferences of the at least one individual.

The resort may be an integrated resort.

The service may be seating guests at an empty table in a restaurant, greeting a guest seated at a table in a restaurant, waitstaff visiting guests seated at a table in a restaurant, waitstaff refilling an empty beverage, waitstaff clearing a table at an end of a meal, waitstaff delivering a check to a guest, or waitstaff turning over a table at a restaurant.

The service standard may be a time to seat the empty table, a time to greet the guest, a number of times the waitstaff visits the guests seated at the table, a time for waitstaff to refill the empty beverage, a time for the guest to receive their food and/or drink after ordering, a time for the waitstaff to clear the table, a time for the waitstaff to deliver the check, or a time for the waitstaff to turnover the table for another guest.

The computer-readable instructions, when executed by the processor, may further cause the computing device to: detect, utilizing the computer vision module, at least one service issue in the images captured by at least one of the cameras; identify, utilizing a facial recognition module, at least one individual in the images captured by at least one of the cameras, the at least one individual being associated with the at least one service issue; and display, on a display of the electronic device, information regarding the at least one service issue and an identification of the at least one individual associated with the at least one service issue.

The computer-readable instructions, when executed by the processor, may further cause the computing device to: detect, utilizing the computer vision module, activity that indicates a guest of the resort requires assistance; and generate an alert on the electronic device that is configured to notify a staff member of the resort that the guest requires assistance.

The computer-readable instructions, when executed by the processor, may further cause the computing device to: detect, with a facial recognition module, at least one VIP guest in the images captured by at least one of the cameras; and generate an alert on the electronic device that notifies a staff member of the resort to the presence of the at least one VIP guest.

The computer-readable instructions, when executed by the processor, may further cause the computing device to: detect, utilizing the computer vision module, service events in the images captured by at least one of the cameras; identify, utilizing a facial recognition module, an individual in the images captured by at least one of the cameras, the individual being associated with the service events; and track and store, on the computing device, the service events as the individual moves through the resort.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable device or method.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a perspective view of a computer-based system that utilizes both facial recognition and computer vision according to one embodiment of the present disclosure;

FIG. 2 is a schematic block diagram of the embodiment of the system illustrated in FIG. 1;

FIG. 3 depicts a facial recognition database according to one embodiment of the present disclosure;

FIG. 4 depicts a computer vision database according to one embodiment of the present disclosure;

FIG. 5A depicts operation of the system according to one embodiment of the present disclosure in which the system is employed in a restaurant;

FIGS. 5B-5D depict a dashboard displayed on a graphical user interface (GUI) of an electronic device according to embodiments of the present disclosure; and

FIG. 6 is a flowchart illustrating tasks of a computer-based method of identifying individuals and tracking the performance of services involving the individuals according to one embodiment of the present disclosure.

### DETAILED DESCRIPTION

The present disclosure relates to various embodiments of a computer-based system that utilizes both facial recognition and computer vision to enhance hospitality services at a resort or other venue. The system is configured to analyze video and/or images captured from one or more cameras at the venue utilizing a facial recognition module (facial recognition engine) to identify one or more individuals in the video and/or images. The system is also configured to analyze the video and/or images captured by the one or more cameras utilizing a computer vision module (computer vision engine) to track the occurrence of one or more events involving the identified individual(s) and/or the performance of one or more services for the identified individual(s), such as restaurant services, valet services, housekeeping services, butler services, retail shop services, pool services, front desk services, limo services, taxi services, public area cleaning services, entertainment services, facilities services, food preparation services, and/or convention services. The system is further configured to compare the service tracked by the computer vision module to one or more service standards (i.e., service metrics) and to report the results of that comparison to the service provider via an electronic device, such as a tablet computer, a headset, or an earpiece. In this manner, the computer-based system of the present disclosure is configured to enable enhanced provision of hospitality services.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements and regions may be exaggerated and/or simplified for clarity. Although relative terms have been used herein to describe a spatial relationship of one element to another, it is understood that these terms are intended to encompass different orientations of the various elements and components of the invention in addition to the orientation depicted in the figures. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

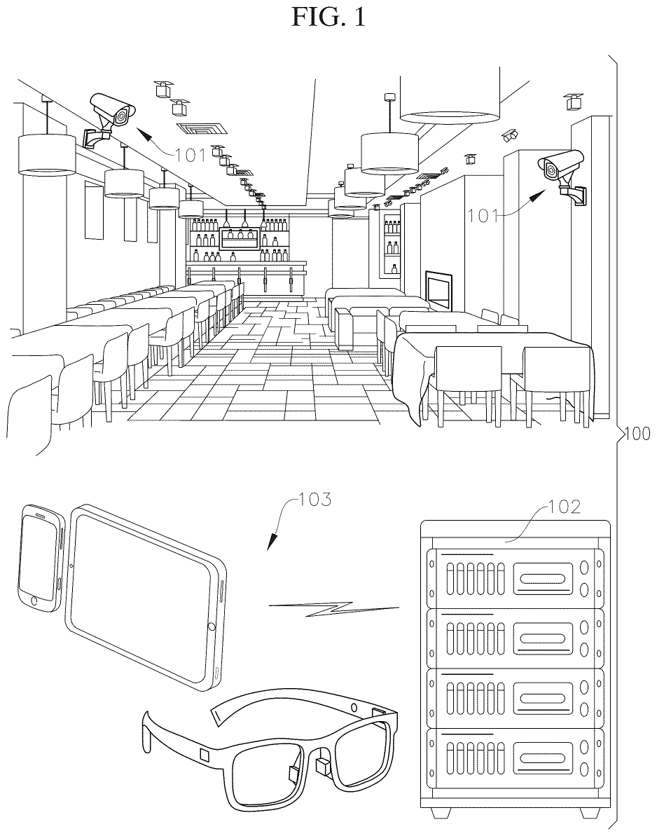

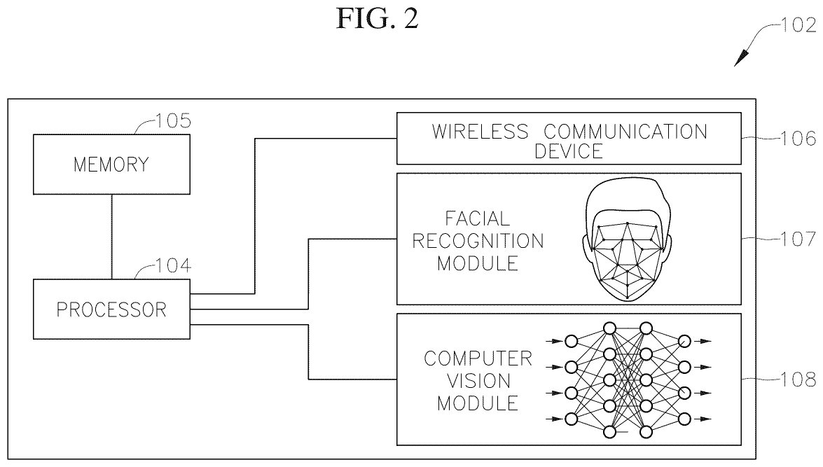

With reference now to FIG. 1, a system 100 according to one embodiment of the present disclosure includes a plurality of cameras 101 (e.g., a plurality of video cameras), a computing device (e.g., a mainframe or a server) 102 configured to receive and process the images captured from the cameras 101, and at least one electronic device 103 in electronic communication with the mainframe or the server 102. The plurality of cameras 101 may be hardwired to the mainframe or the server 102 or connected to the mainframe or server 102 via a wireless network. The mainframe or server 102 includes a processor 104, a non-transitory memory device 105 in communication with the processor 104, and a wireless communication device 106 in communication with the processor 104. The non-transitory memory device 105 includes a facial recognition module 107 (e.g., a facial recognition engine) configured to identify one or more individuals in the images captured by the cameras 101, and a computer vision module 108 (e.g., a computer vision engine) configured to identify the performance of one or more services and/or the occurrence of one or events in the images captured by the cameras 101.

The system 100 may be utilized in a resort or other venue, such as a casino, a restaurant, or a valet area of a hotel. In one or more embodiments, the system 100 may be employed at an integrated resort, which is a large entertainment complex that combines multiples amenities, such as a casino, a hotel, dining facilities, retail stores, and an entertainment venue. The mainframe or server 102 may be located at the resort or other venue or remote from the resort or other venue.

As used herein, the term “processor” includes any combination of hardware, firmware, memory and software, employed to process data or digital signals. The hardware of a controller may include, for example, a microcontroller, application specific integrated circuits (ASICs), general purpose or special purpose central processors (CPUs), digital signal processors (DSPs), graphics processors (GPUs), and programmable logic devices such as field programmable gate arrays (FPGAs). In a processor, as utilized herein, each function is performed either by hardware configured, i.e., hard-wired, to perform that function, or by more general purpose hardware, such as a CPU, configured to execute instructions stored in a non-transitory storage medium or memory. A processor may contain two or more processors, for example, a processor may include two processors, an FPGA and a CPU, interconnected on a PCB. The non-transitory memory device may be any suitable type or kind of memory, such non-transitory read/write memory (e.g., flash memory, hard disk drives (HDD), or solid state drives (SDD)), non-transitory read-only memory (ROM) (e.g., programmable read-only memory (PROM) or erasable programmable read-only memory (EPROM)), or a combination thereof.

The wireless communication device 106 may utilize any suitable wireless communication protocol to communicate with the electronic device 103, such as a Bluetooth communication protocol, a Wi-Fi communication protocol (e.g., an IEEE 802.11x standard), or an equivalent wireless communication protocol that would allow secure wireless communications with the electronic device 103.

In one or more embodiments, the electronic device 103 may be a tablet computer, a computer monitor, a virtual reality headset, an augmented reality headset, a smart watch, a smartphone, an earpiece, any other suitable type or kind of electronic device, or a combination thereof. As described in more detail below, the electronic device 103 is configured to generate an alert (e.g., an audio alert, such as a chime or a voice message, and/or a visual alert, such as a text-based alert or graphic) in response to one or more services being performed below the associated service standard.

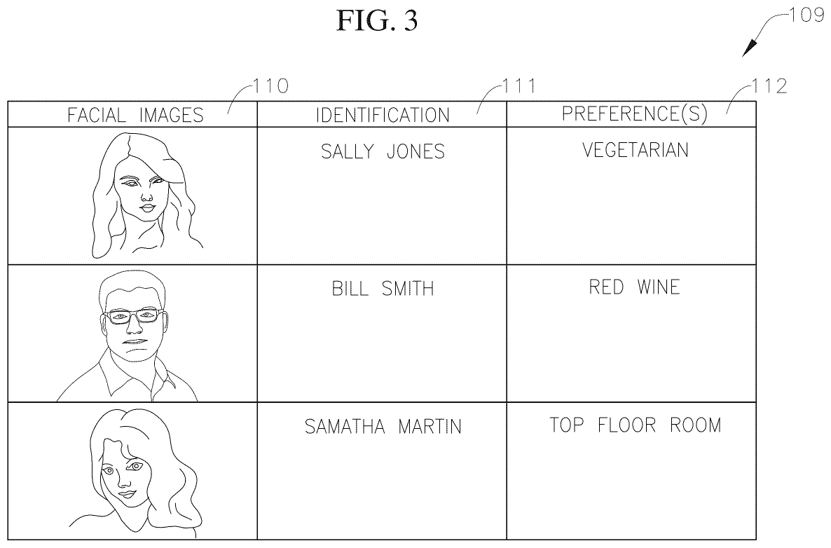

With reference now to the embodiment depicted in FIG. 3, the facial recognition module 107 stored on the non-transitory memory device 105 includes a facial recognition database 109. In one or more embodiments, the facial recognition database 109 includes a table having a plurality of fields, including a facial images field 110 and a personal identifier (identification) field 111. The facial images field 110 includes a plurality of facial images (i.e., each entry under the facial images field 110 includes at least one facial image) and the personal identifier (identification) field 111 includes a plurality of names or customer IDs associated with the facial images (i.e., each entry under the personal identifier field 111 includes a name and/or customer ID number). That is, each entry in the facial recognition database 109 includes one or more facial images of a particular individual and an associated personal identifier (e.g., name and/or customer ID) of that particular individual. In one or more embodiments, each of the facial images may be (or may include) a vector map (i.e., a depth map) at a plurality of points across the facial image.

In one or more embodiments, the facial recognition database 109 also includes a personal preferences field 112 including a plurality of preferences, such as meal preferences (e.g., vegetarian) and/or drink preferences (e.g., red or white wine), associated with the facial images in the facial images field 110 and the associated personal identifiers in the personal identifier field 111. In one or more embodiments, the personal preferences may be the individual's preferred type of room in a hotel, the individual's preferred seating location or table in a restaurant, the individual's preferred seating location (or game type) at a casino, the individual's preferred game speed of a casino table, and/or the individual's preferred style of a dealer at a casino table. In one or more embodiments, each entry in the personal preferences field 112 may include one or more preferences associated with an individual, although in one or more embodiments only some of the entries in the preferences field may include one or more associated preferences (i.e., some of the entries in the personal preferences field 112 may be empty). In one or more embodiments, the facial recognition database 109, which includes a field 110 containing facial images, a field 111 containing personal identification information, and a field 112 containing individual preferences, may be a lookup table. In one or more embodiments, the entries in the personal preferences field 112 are editable (e.g., read-write operations may be performed with respect to the entries under the personal preferences field 112).

In operation, the facial recognition module 107 is configured to access the facial recognition database 109 to identify the individual(s) in the video and/or images captured by the one or more cameras 101. In one or more embodiments, the facial recognition module 107 is configured to receive an image of an individual's face captured by one or more of the cameras 101 and to compare that image to the facial images stored in the facial images field 110 of the facial recognition database 109. In one or more embodiments, the facial recognition module 107 may be configured to generate a vector map (e.g., a depth map) at a plurality of points across the facial image captured by one or more of the cameras 101 and to compare the vector map to the vector maps of the facial images stored in the facial recognition database 109. In one or more embodiments, the facial recognition module 107 is configured to positively identify an individual in response to the comparison returning a match above a threshold value, such as approximately 80% or approximately 90%. In one or more embodiments, the facial recognition module 107 may utilize a Siamese artificial neural network trained to identify individuals in the images captured by one or more of the cameras 101 (e.g., the facial recognition module 107 may utilize two identical artificial subnetworks, each having the same weights between the nodes in the layers, to process the image captured by the one or more cameras 101 and the facial images in the facial recognition database 109 and to generate feature embeddings, and then compare those feature embeddings using a distance function to determine the similarity between the facial images and thereby identify the individual(s) in the image(s) captured by the camera(s) 101).

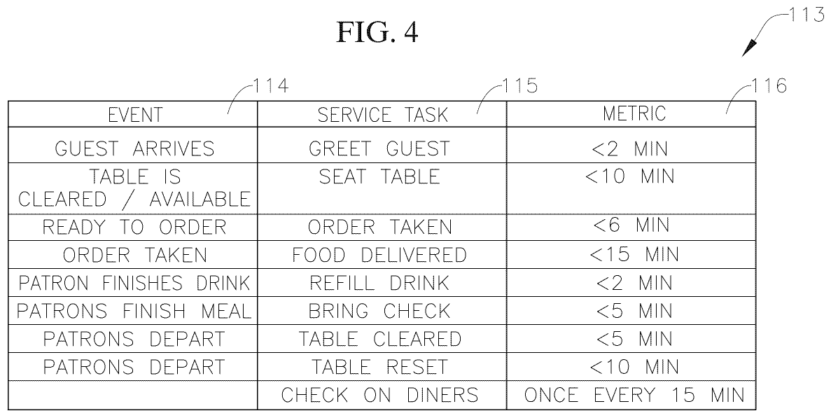

With reference now to the embodiment depicted in FIG. 4, the computer vision module 108 stored on the non-transitory memory device 105 includes a computer vision database 113. In one or more embodiments, the computer vision database 113 includes a table having a plurality of fields, including an event field 114, a service task field 115, and a metric field 116. The event field 114 includes a plurality of events (i.e., each entry under the event field 114 includes a different event, such as a guest arriving, a table being cleared or otherwise becoming available, the guest(s) are ready to order, a patron finishes a drink, a patron finishes a meal, or the patron(s) depart from the restaurant), the service task field 115 includes a plurality of services associated with the events listed in the event field 114, such as greeting the guest, seating guest(s) at a table, taking an order for food and/or drinks, delivering the ordered food, refilling a drink, bringing the check, clearing the table, and checking on the diner(s)). The metric field 116 includes a plurality of service metrics or standards (e.g., a threshold time to complete a given service, the frequency of performing a given service, the number of times the service is performed) associated with service tasks listed under the service task field 115. In one or more embodiments, the metric field 116 in the computer vision database 113 may be adjusted (or determined) based on the individual preferences in the personal preferences field 112 in the facial recognition database 109. Accordingly, in one or more embodiments, the service metric/standard may be individualized rather than uniform for every individual.

In one or more embodiments, the computer vision module 108 is an artificial neural network (e.g., a convolutional neural network (CNN)) trained on a corpus of images and/or videos depicting various hospitality services. In one or more embodiments, the computer vision module 108 may be configured to detect the performance of restaurant services provided by waitstaff, such as (i) detecting when a guest is seated at a table and is ready to order; (ii) detecting when a guest needs another beverage; (iii) detecting when a guest is trying to get the attention of waitstaff; (iv) detecting when a guest has finished eating; (v) detecting when a guest has left the table; and/or (vi) detecting when a table is set and ready for the next guest. Additionally, in one or more embodiments, the computer vision module 108 may be configured to calculate the time between any of the above-listed events and/or calculate the number of the above-listed events that occur in a specified time period. In one or more embodiments, the system 100 may be configured to send a signal, via the wireless communication device 106, to the electronic device 103 that is configured to cause the electronic device 103 to generate an alert based on information calculated or determined by the computer vision module 108 and/or to display information calculated or determined by the computer vision module 108, such as displaying the timing of the above-listed events based on service standards, displaying the performance of the services relative to the associated service standards, and/or notifying an individual in response to certain thresholds or performance rules being satisfied.

In one or more embodiments, the computer vision module 108 may be configured to detect the performance of services or the occurrence of events in a casino. In one or more embodiments, the computer vision module 108 may be an artificial neural network trained on a corpus of images to detect the performance of services or the occurrence of events in a casino, such as (i) detecting when a gaming table is idle; (ii) detecting when a gaming table is occupied; (iii) detecting when a gaming table has reached its optimal occupancy; (iv) detecting when a table game is moving slower than average; (v) detecting when a table game is moving faster than average; (vi) detecting when a table game is over max occupancy; and/or (vii) detecting when player behavior is interesting, such as stopping play, starting play, passing chips, large bets, small bets, long play, short play, playing as a pair, etc. Additionally, in one or more embodiments, the computer vision module 108 may be configured to calculate the time between any of the above-listed events and/or calculate the number of the above-listed events that occur in a specified time period. In one or more embodiments, the system 100 may be configured to send a signal, via the wireless communication device 106, to the electronic device 103 that is configured to cause the electronic device 103 to generate an alert based on information calculated or determined by the computer vision module 108 and/or to display information calculated or determined by the computer vision module 108, such as displaying game performance information and/or notifying an individual in response to certain thresholds or performance rules being satisfied.

In one or more embodiments, the computer vision module 108 may be configured to determine the performance of a service or the occurrence of an event directly or indirectly. For instance, in one or more embodiments, the computer vision module 108 may be configured to determine that a patron has finished his drink by detecting the level of the liquid in the glass (i.e., directly measuring that the amount of drink that is remaining) or by detecting the angle and/or elevation of the glass relative to the patron as the person takes a sip from the glass (i.e., indirectly measuring the amount of drink that is remaining). For instance, the computer vision module 108 may be configured to determine that a patron has finished his drink in response to the angle and/or elevation of the glass exceeding a threshold angle and/or threshold elevation.

In one or more embodiments, the computer vision module 108 may be configured to determine or detect one or more service issues or service problems (e.g., by comparing the image(s) captured by one or more cameras 101 to known service issues stored in the computer vision database 113) and the facial recognition module 107 may be configured to identify the individual(s) affected by the service issue(s) determined by the computer vision module 108 (e.g., by comparing the image(s) captured by one or more cameras 101 to the facial images stored in the facial recognition database 109). Additionally, in one or more embodiments, the system 100 may cause a display of the electronic device 103 to display information regarding the service issue and an identification (e.g., a name, a customer ID, and/or a facial image) of the individual(s) affected by the service issue(s). In one or more embodiments, the information regarding the service issue and the identification of the individual(s) affected by the service issue(s) may be stored on the computing device 102.

In one or more embodiments, the system 100 may be configured to cause a display of the electronic device 103 to display a leaderboard including a list of identities (e.g., names, customer IDs, and/or facial images) of the individuals identified by the facial recognition database 109 and the associated performance of the service as determined by the computer vision module 108 relative to the relevant performance metric (e.g., based on a comparison of the service events determined by the computer vision module 108 and the performance metric associated with that service event). In one or more embodiments, the listings in the leaderboard may be arranged in rank-order based on the performance of the service relative to the associated service metric (e.g., the fastest service (and the associated individual for whom that service is performed) may be listed at the top and the remaining services (and associated individuals) may be listed in descending order, or the slowest service (and the associated individual for whom that service is performed) may be listed at the top and the remaining services (and associated individuals) may be listed in ascending order). In one or more embodiments, the leaderboard may rank the individuals (and the associated performance of the service relative to the performance metric) in any other suitable order, such as alphabetical order by last name or numerical order by customer ID.

In one or more embodiments, the computer vision module 108 may be configured to determine or detect activity that indicates a guest of the resort requires assistance (e.g., by comparing the image(s) captured by one or more cameras 101 to known activities that indicate a guest requires assistance stored in the computer vision database 113).

In one or more embodiments, the system 100 is configured to notify a staff member of the resort (e.g., by generating an alert on the electronic device 103, such as visual, audio, and/or haptic alert) in response to the identification of certain individuals (e.g., VIP guests) by the computer vision module 108.

In one or more embodiments, the computer vision module 108 may be configured to determine or detect one or more service events (e.g., by comparing the image(s) captured by one or more cameras 101 to known service events stored in the computer vision database 113), the facial recognition module 107 may be configured to identify the individual(s) affected by the service event determined by the computer vision module 108 (e.g., by comparing the image(s) captured by one or more cameras 101 to the facial images stored in the facial recognition database 109), and the system 100 may be configured to track and store, on the computing device 102, these service events regarding a particular individual as they occur across the resort.

In one or more embodiments, the facial recognition database 109 and the computer vision database 113 may be stored on the same non-transitory memory device or different non-transitory memory devices (e.g., the facial recognition database 109 and the computer vision database 113 may be stored on the same or different servers or the same or different mainframes).

In one or more embodiments, the computing device (e.g., the mainframe or the server) 102 may be configured to provide access to information regarding the service events determined by the computer vision module 108, the individuals identified by the facial recognition module 107, the facial recognition database 109 (or a portion(s) thereof, such as the personal preferences), and/or the computer vision database 113 (or a portion(s) thereof, such as the service standards/metrics) via an application programming interface (API).

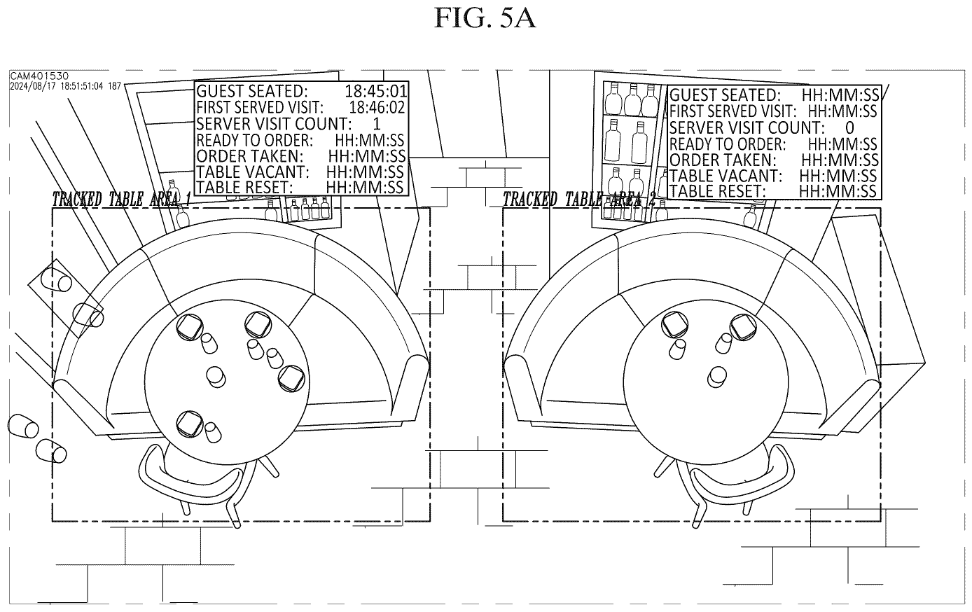

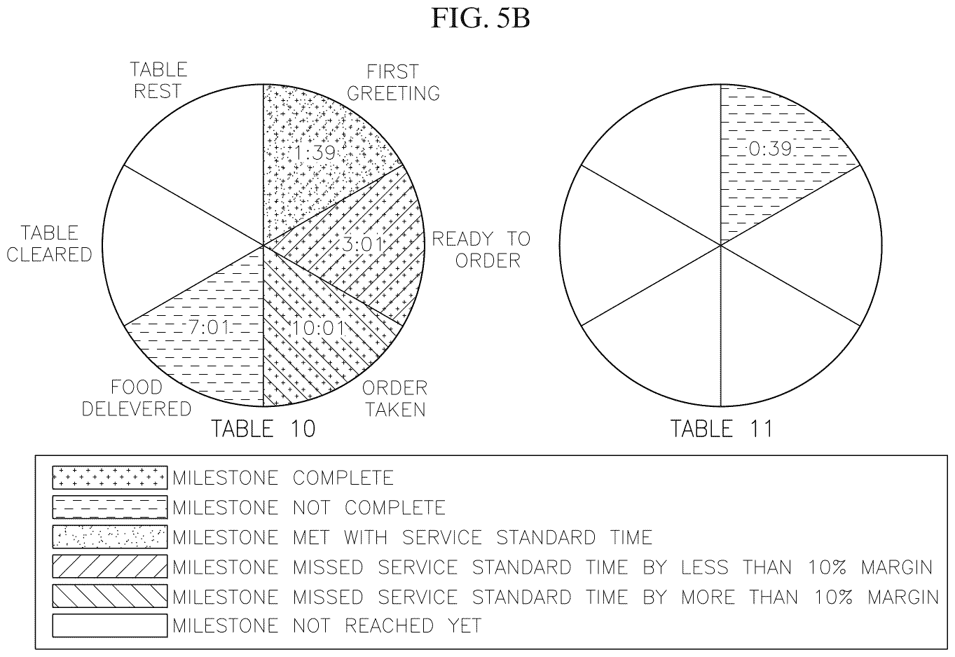

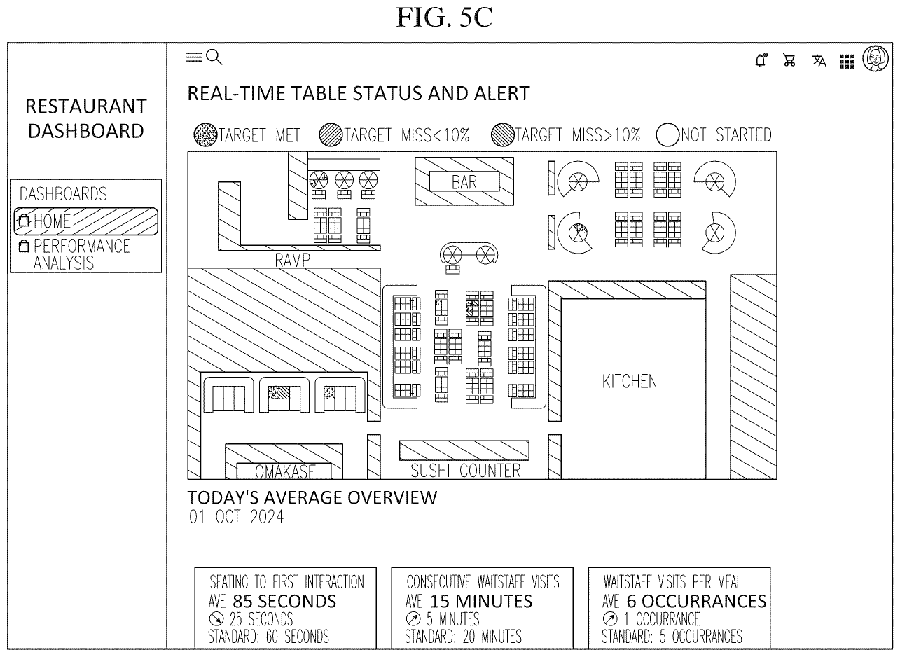

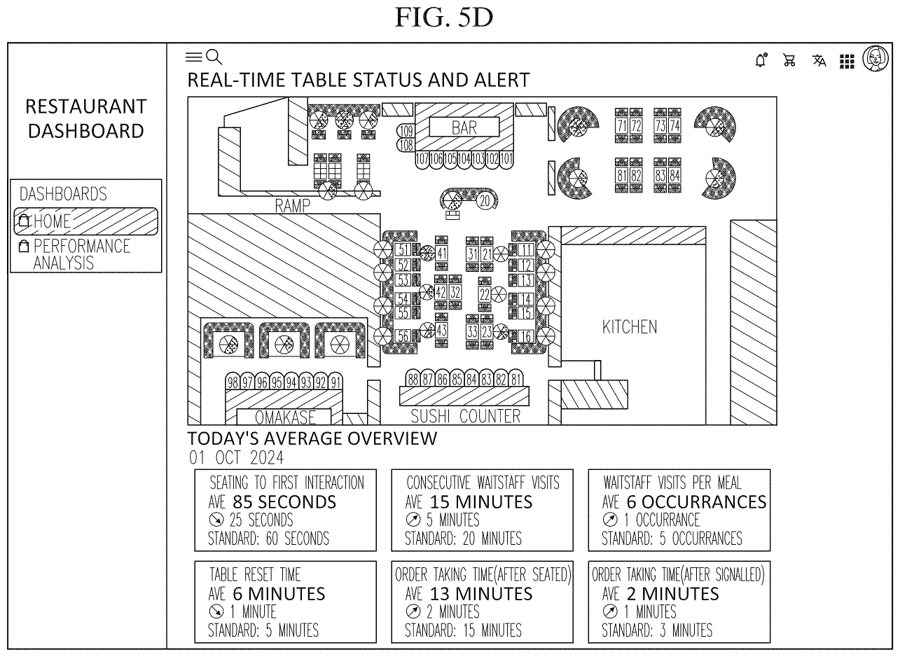

FIG. 5A depicts operation of the system 100 according to one embodiment of the present disclosure in which the system is employed in a restaurant. As illustrated in FIG. 5A, the system 100 is configured to track the time at which the guest(s) are seated, the time at which the guest(s) are first visited by waitstaff, the number of times the waitstaff (e.g., a server) visits the guest(s) at the table, the time at which the guest(s) are ready to order, the time at which the order is taken by the waitstaff, the time at which the table becomes vacant (i.e., the time at which the guest(s) finish their meal and leave the table), and the time at which the table is reset after the guest(s) depart.

FIG. 5B is a view of a dashboard displayed on a graphical user interface (GUI) of an electronic device (e.g., a tablet computer) according to one embodiment of the present disclosure. As illustrated in FIG. 5B, for each table that is occupied by one or more patrons (e.g., Table 10 and Table 11), the GUI displays a circle divided into sectors (e.g., a pie chart) and each sector of the circle is associated with a different service provided by the waitstaff. As shown in FIG. 5B, the circle is divided into six (6) sectors that represent six (6) different services provided by the waitstaff: (i) resetting the table after a prior group of patrons finished dining (“table reset”); (ii) greeting the patrons (“first greeting”); (iii) the patrons are ready to order (“ready to order”); (iv) the patrons'food orders are taken (“order taken”); (v) the food is delivered to the table by the waitstaff (“food delivered”); and (vi) the table is cleared for the next group of patrons (“table cleared”). In one or more embodiments, for each service milestone, the time to complete the milestone is indicated in the associated sector. In one or more embodiments, the service milestone may not be a time (e.g., the service milestone may be number of times a particular event occurs or the frequency of the occurrence of that event) and in those embodiments the GUI may display the associated standard in the relevant sector of the circle.

Additionally, in one or more embodiments, for each service milestone, the corresponding sector of the circle is color or shaded to indicate whether or not the service milestone was completed within the associated service standard (e.g., the service standard time). For instance, the sector may be transparent or white when the service milestone has not yet been completed; green when the service milestone was completed according to the service standard (e.g., within the service standard time); yellow when the service milestone was not completed according to the service standard but the service standard was missed by less than a 10% margin; and red when the service milestone missed the service standard by more than a 10% margin. In one or more embodiments, the sectors may be shaded with any other colors to indicate whether or not the service standards were satisfied. Additionally, although in the illustrated embodiment the circle is divided into six sectors, in one or more embodiments the circle may be divided into any other suitable number of sectors depending on the number of service milestones that are tracked by the system.

Although in the illustrated embodiment the graphic is a circle divided into sectors, in one or more embodiments the graphic may have any other suitable shape or shapes, such as a square, a rectangle, a triangle, etc. For instance, in one or more embodiments, the shape of the graphic may correspond to the shape of the table or seating area at which the patrons are seated (e.g., a rectangle may be used for a rectangular table and a circle may be used for a circular table).

FIGS. 5C-5D depict a dashboard displayed on a graphical user interface (GUI) of an electronic device (e.g., a tablet computer) according to one embodiment of the present disclosure. In the illustrated embodiment, the dashboard displays a graphical representation of the layout of a restaurant, including seating areas (e.g., tables and booths), a kitchen area, a bar area, a sushi counter. Additionally, in one or more embodiments, for each table that is occupied by one or more patrons, the GUI displays a graphic indicating the performance of various services by waitstaff for that table. For instance, in the illustrated embodiment, the GUI displays a graphic depicting the various services performed by the waitstaff, the time to complete those services, and an indication whether the services were performed within the associated service standard. In one or more embodiment, the graphic may be the segmented circle depicted in FIG. 5B.

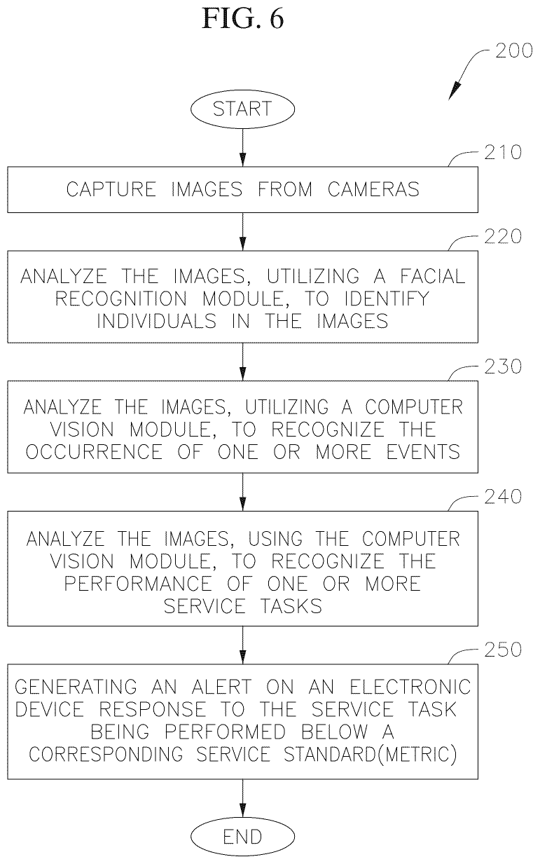

FIG. 6 is a flowchart illustrating tasks of a computer-implemented method 200 of identifying individuals and tracking the performance of services involving the individuals according to one embodiment of the present disclosure.

In the illustrated embodiment, the method 200 includes a task 210 of capturing images (e.g., video and/or static images) from one or more cameras. The cameras may be positioned in a resort (e.g., an integrated resort) or other venue, such as a casino, a restaurant, or a valet area of a hotel.

In the illustrated embodiment, the method 200 also includes a task 220 of analyzing the images captured by the cameras in task 210, utilizing a facial recognition module, to identify individuals in the images.

In the illustrated embodiment, the method 200 also includes a task 230 of analyzing the images captured by the cameras in task 210, utilizing a computer vision module, to recognize the occurrence of one or more events (e.g., one or more actions taken by a patron at an integrated resort, such as a patron finishing their drink).

In the illustrated embodiment, the method 200 also includes a task 240 of analyzing the images captured by the cameras in task 210, utilizing the computer vision module, to recognize the performance of one or more service tasks (e.g., refilling a drink) associated with the event identified in task 230.

Although in the illustrated embodiment the task 220 of analyzing the images with the facial recognition module is performed before the tasks 230 and 240 of analyzing the images with the computer vision module, in one or more embodiments these tasks 220, 230, and 240 may be performed in any other suitable order. For instance, in one or more embodiments, the tasks 230 and 240 of analyzing the images with the computer vision module may be performed before the task 220 of analyzing the images with the facial recognition module.

In the illustrated embodiment, the method 200 also includes a task 250 of generating an alert on an electronic device (e.g., a computer tablet, a smartphone, and/or AR/VR glasses) in response to the service task recognized in task 240 being performed below a corresponding service standard (metric). The task 250 may include referencing the service standard (metric) stored in the computer vision database. The alert generated in task 250 may be an audio alert, a visual alert, an audio-visual alert, or a haptic alert.

The facial recognition module and/or the computer vision module according to embodiments of the present invention described herein may be implemented utilizing any suitable hardware, firmware (e.g. an application-specific integrated circuit), software, or a combination of software, firmware, and hardware. For example, the facial recognition module and the computer vision module may be stored and executed on one integrated circuit (IC) chip or on separate IC chips. Further, the facial recognition module and/or the computer vision module may be implemented on a flexible printed circuit film, a tape carrier package (TCP), and/or a printed circuit board (PCB). Further, the facial recognition module and/or the computer vision module may execute a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Although some embodiments of the present disclosure are disclosed herein, the present disclosure is not limited thereto, and the scope of the present disclosure is defined by the appended claims and equivalents thereof.

What is claimed is:

1. A computer system configured to facilitate hospitality services in a resort, the computer system comprising:
a plurality of cameras configured to capture images of at least a portion of the resort;
a computing device in electronic communication with the plurality of cameras, the computing device comprising a processor and a non-transitory memory device in communication with the processor,
wherein the non-transitory memory device comprises computer-readable instructions which, when executed by the processor, cause the computing device to:
receive the images captured by at least one of the plurality of cameras; and
determine, utilizing a computer vision module, an occurrence of a service event in the images captured by at least one of the plurality of cameras; and
an electronic device in electronic communication with the computing device, wherein the electronic device is configured to display information regarding the service event.

2. The computer system of claim 1, wherein the computer-readable instructions, when executed by the processor, further cause the computing device to:
determine, utilizing the computer vision module, performance of a service related to the service event; and
compare the performance of the service to a service standard stored in the non-transitory memory device;
wherein the electronic device is configured to display information regarding the service event and the service standard.

3. The computer system of claim 2, wherein the computing device is configured to provide access to the information via an application programming interface (API).

4. The computer system of claim 2, wherein the electronic device is selected from the group consisting of a tablet computer, a computer monitor, a virtual reality headset, an augmented reality headset, a smart watch, a smartphone, and an earpiece.

5. The computer system of claim 1, wherein the electronic device is configured to generate an alert in response to the service not meeting the service standard, and wherein the alert is an auditory alert or a visual alert.

6. The computer system of claim 1, wherein the instructions, when executed by the processor, further cause the computing device to identify, utilizing a facial recognition module, at least one individual in the images captured by at least one of the plurality of cameras.

7. The computer system of claim 6, wherein the electronic device is a display device, and wherein the display device is configured to display a graphical user interface comprising a graphical representation of a layout of the portion of the resort, an identification of a location of the at least one individual in the layout, and the service standard associated with the at least one individual.

8. The computer system of claim 7, wherein the display device is further configured to display an identity of the at least one individual.

9. The computer system of claim 8, wherein the graphical user interface further comprises a leaderboard, the leaderboard comprising a plurality of identities of individuals and a plurality of associated performance metrics.

10. The computer system of claim 6, wherein the non-transitory memory device comprises a facial recognition database comprising a plurality of facial images, a plurality of identifications associated with the plurality of facial images, and a plurality of preferences associated with the plurality of identifications.

11. The computer system of claim 10, wherein the non-transitory memory device comprises a computer vision database comprising a plurality of events, a plurality of service tasks associated with the plurality of events, and a plurality of service standards associated with the plurality of service tasks.

12. The computer system of claim 11, wherein at least one service standard of the plurality of service standards is based on a preference of the plurality of preferences.

13. The computer system of claim 1, wherein the computer vision module comprises a convolutional neural network.

14. The computer system of claim 1, wherein the computer-readable instructions, when executed by the processor, further cause the computing device to determine, utilizing the computer vision module, an occurrence of an event involving the at least one individual.

15. The computer system of claim 14, wherein the event is selected from the group consisting of a guest arriving at a restaurant, a table becoming available, the guest being ready to order, the guest finishing a drink, the guest finishing a meal, and the guest departing the restaurant.

16. The computer system of claim 1, wherein the service standard is selected from the group consisting of a time duration, a frequency, and a number of occurrences.

17. The computer system of claim 1, wherein the service event is an interaction between one or more team members of the resort and one or more guests of the resort.

18. The computer system of claim 1, wherein the portion of the resort is selected from the group consisting of a restaurant, a front desk area, a casino, a convention space, a meeting room, a housekeeping area, a pool area, a retail shop, and a valet area.

19. The computer system of claim 18, wherein the service event is a service provided at at least one of the restaurant, the front desk, the casino, the convention space, the meeting room, the housekeeping area, the pool area, the retail shop, or the valet area.

20. The computer system of claim 6, wherein the non-transitory memory device stores preferences of the at least one individual, and wherein the computer-readable instructions, when executed by the processor, cause a display of the electronic device to display a name of the at least one individual and the preferences of the at least one individual in response to the facial recognition module identifying the at least one individual.

21. The computer system of claim 20, wherein the preferences comprise meal preferences of the at least one individual.

22. The computer system of claim 20, wherein the preferences comprise personal preferences selected from the group consisting of room type in a hotel, seating in a restaurant, seating at a casino, game speed of a casino table, and style of a dealer at a casino table.

23. The computer system of claim 1, wherein the resort is an integrated resort.

24. The computer system of claim 1, wherein the service is selected from the group consisting of seating guests at an empty table in a restaurant, greeting a guest seated at a table in a restaurant, waitstaff visiting guests seated at a table in a restaurant, waitstaff refilling an empty beverage, waitstaff clearing a table at an end of a meal, waitstaff delivering a check to a guest, and waitstaff turning over a table at a restaurant.

25. The computer system of claim 24, wherein the service standard is selected from the group consisting of a time to seat the empty table, a time to greet the guest, a number of times the waitstaff visits the guests seated at the table, a time for waitstaff to refill the empty beverage, a time for the guest to receive their food and/or drink after ordering, a time for the waitstaff to clear the table, a time for the waitstaff to deliver the check, and a time for the waitstaff to turnover the table for another guest.

26. The computer system of claim 1, wherein the computer-readable instructions, when executed by the processor, further cause the computing device to:
detect, utilizing the computer vision module, at least one service issue in the images captured by at least one of the plurality of cameras;
identify, utilizing a facial recognition module, at least one individual in the images captured by at least one of the plurality of cameras, the at least one individual being associated with the at least one service issue; and
display, on a display of the electronic device, information regarding the at least one service issue and an identification of the at least one individual associated with the at least one service issue.

27. The computer system of claim 1, wherein the computer-readable instructions, when executed by the processor, further cause the computing device to:
detect, utilizing the computer vision module, activity that indicates a guest of the resort requires assistance; and
generate an alert on the electronic device, the alert being configured to notify a staff member of the resort that the guest requires assistance.

28. The computer system of claim 1, wherein the computer-readable instructions, when executed by the processor, further cause the computing device to:
detect, with a facial recognition module, at least one VIP guest in the images captured by at least one of the plurality of cameras; and
generate an alert on the electronic device, the alert notifying a staff member of the resort to the presence of the at least one VIP guest.

29. The computer system of claim 1, wherein the computer-readable instructions, when executed by the processor, further cause the computing device to:
detect, utilizing the computer vision module, a plurality of service events in the images captured by at least one of the plurality of cameras;
identify, utilizing a facial recognition module, an individual in the images captured by at least one of the plurality of cameras, the individual being associated with the plurality of service events; and
track and store, on the computing device, the plurality of service events as the individual moves through the resort.
